(19) United States
(12) Patent Application Publication
(10) Pub. No.: US 2015/0205926 A1
(43) Pub. Date: Jul. 23, 2015

(54) Systems, Methods and Products for an Insurance Coverage

(71) Applicant: Trustmark Insurance Company, Long Island City, NY (US)

(72) Inventors: Les McPhearson, Vernon Hills, IL (US); Julie Pohjola, Trevor, WI (US); Matt Fleischman, Antioch, IL (US); Scott Smith, Brookfield, WI (US); Jean Park, Northbrook, IL (US); Howard N. Fixler, Worcester, MA (US); John Dembowski, Ashby, MA (US)

(21) Appl. No.: 14/508,165

(22) Filed: Oct. 7, 2014

Related U.S. Application Data
(60) Provisional application No. 61/930,733, filed on Jan. 23, 2014.

(51) Int. Cl. G06F 19/00

(52) U.S. Cl. CPC G06F 19/328; G06F 19/322

(57) ABSTRACT

An insurance system receives a claim based on an insurance policy for an illness. A processor determines a level of severity of the illness based on the claim. The processor determines a payout based on the level of severity of illness, where the payout comprises a staggered percentage of a maximum payout under the insurance policy. The payout can then be paid to the insured.

### RELATED APPLICATIONS

The present application claims the benefit of co-pending U.S. Provisional Patent Application No. 61/930,733, filed Jan. 23, 2014, the entire contents of which is incorporated by reference herein.

### FIELD OF THE INVENTION

The present disclosure relates generally to systems and methods related to insurance products, and to health insurance products that cover illnesses over various stages of the illnesses.

### BACKGROUND

Supplemental critical illness insurance appeared on the market as a response to the need for supplemental insurance for the substantial financial impact that a critical illness can bring about in a person's life. In order for insurance companies to keep costs low, these types of policies typically include strict definitions of severe conditions, as well as strict time periods regarding when a benefit can be triggered. For example, cancer is only eligible for a benefit if it was considered invasive cancer and had reached a stage of severity. Additionally, if a person were to suffer another critical illness, such as a heart attack after a diagnosis of cancer, the heart attack would not be eligible for payment unless a certain amount of time, such as six months, had passed between the date cancer was diagnosed to the date a heart attack occurred. This approach has allowed premiums to remain low, while safeguarding the industry from having to pay out for these severe critical illnesses on frequent basis. Innovation in the market has come in the form of adding new eligible conditions while maintaining an insurer's risk level, which means that the new conditions have a low likelihood of occurring. Adding a new condition such as bacterial meningitis allows an insurer to boast about covering more conditions than a competitor, while also safeguarding against frequent payout of the condition due to the low likelihood of occurrence in the general population.

### BRIEF DESCRIPTION OF THE DRAWINGS

The disclosure can be better understood with reference to the following drawings and description. The components in the figures are not necessarily to scale, emphasis instead being placed upon illustrating principles of the disclosure.

FIG. 1 is an exemplary computing system for implementing aspects of the critical illness coverage products, systems and methods.

FIG. 2 is a flowchart of an exemplary workflow for processing insurance claims.

FIG. 3 is a block diagram of an exemplary payout for a cerebral vascular disease according to a first scenario.

FIG. 4 is a block diagram of an exemplary payout for a cerebral vascular disease according to a second scenario.

FIG. 5 is a block diagram of an exemplary payout for a cerebral vascular disease according to a third scenario.

FIG. 6 is a block diagram of an exemplary payout for cancer according to a first scenario.

FIG. 7 is a block diagram of an exemplary payout for cancer according to a second scenario.

FIG. 8 is a block diagram of an exemplary payout for cancer according to a third scenario.

FIG. 9 is a block diagram of an exemplary payout for cancer according to a fourth scenario.

FIG. 10 is a block diagram of an exemplary payout for cancer according to a fifth scenario.

FIG. 11 is a block diagram of an exemplary payout for coronary related diseases according to a first scenario.

FIG. 12 is a block diagram of an exemplary payout for coronary related diseases according to a second scenario.

FIG. 13 is a block diagram of an exemplary payout for coronary related diseases according to a third scenario.

FIG. 14 is a block diagram of an exemplary payout for multiple conditions according to a first scenario.

FIG. 15 is a block diagram of an exemplary payout for multiple conditions according to a second scenario.

### DETAILED DESCRIPTION

Systems, methods and products can address a spectrum of events surrounding critical illnesses that individuals encounter, from proactive risk identification and preventive treatment, to coverage for early identification of a disease through several stages of possible progression. For example, an insured can get benefits for biometric screening, early detection and prevention tests and genetic tests as well as benefits for early stage and late stage benefits for cancer, coronary artery disease and cerebral vascular disease. A benefit is also available when the provision of caregiving services to a family member who has a critical illness is required.

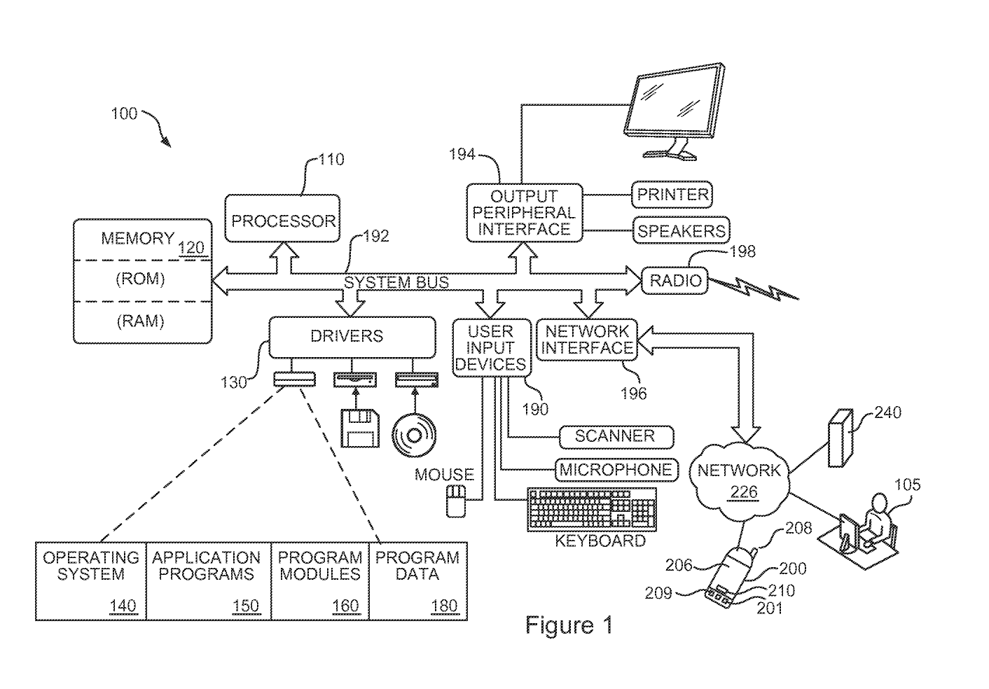

FIG. 1 is an exemplary computing system for implementing aspects of the critical illness coverage systems, methods and products. For purposes of explanation, the critical illnesses are described for cancer, heart attack, stroke and coronary disease, but the systems, methods and products can be used for other types of illness as well. The computing system 100 can be any one of or any combination of a personal computers 105, a remote servers 240, a mobile device 200, etc. of an insured client and an insurance provider. The computing system 100 may include a portable device and/or may remain stationary during use.

The computing system 100 can be used to implement various insurance related workflows, from benefit administration system case set-up by the insurance provider to claims processing of the insured's claims. Case set-up can include detailing a coverage for sale, deploying information about the coverage, training the insurance providers' vendors on the coverage, enrolling clients, the insured, in the coverage, saving the enrollment contracts and coverage information, billing the clients, etc. Claims workflow includes receiving notice of claims, processing claim forms, processing approval, denial or recession of claims, etc. described in more detail below.

To process case set-ups and insurance claims, the computing system 100 can include a processor 110 for executing computer readable instructions stored in the memory 120 to perform one or more of the functions described herein, and one or more drives 130. The drives 130 and their associated computer readable memory medium provide storage of the computer readable instructions, data structures, program modules and other data to be transformed by the computing system 100, as described herein. Drives 130 can include an operating system 140, application programs 150, program modules 160, and program data 180.

The computing systems 100 of the insurance provider and insured can further includes input devices 190, e.g., scanner, microphone, keyboard and mouse, through which data may enter the computing system 100 for processing, either automatically or by a user who enters commands and data. These and other input devices 190 can be connected to processor 110 through a user input interface that is coupled to a system bus 192, but may be connected by other interface and bus structures, such as a parallel port or a universal serial bus (USB). Computers such as computing system 100 may also include peripheral output devices such as speakers, printers, and/or display devices, which may be connected through an output peripheral interface 194 and the like. Computing system 100 can also include a radio 198 or other type of communications device for wirelessly transmitting and receiving data for the computing system 100 with the aid of an antenna. When used in a LAN or WLAN networking environment, computing system 100 can be connected to the LAN through a network interface 196 or an adapter.

The mobile device 200 of the computing system 100 can include any portable electronic device of the insurance provider and/or insured. The mobile device 200 includes a processor 201 for executing applications and a display 206, e.g., for displaying coverage and/or claim information connected with the processor 201. The mobile device can include an input 210, e.g., for entering coverage or claims information for further processing. An antenna 208 is connected with the processor 201 and network interface 209, and capable of sending and receiving information, e.g., coverage and claim information, between one or more other computers, e.g., 100, 105, 240, connected with the mobile device 200.

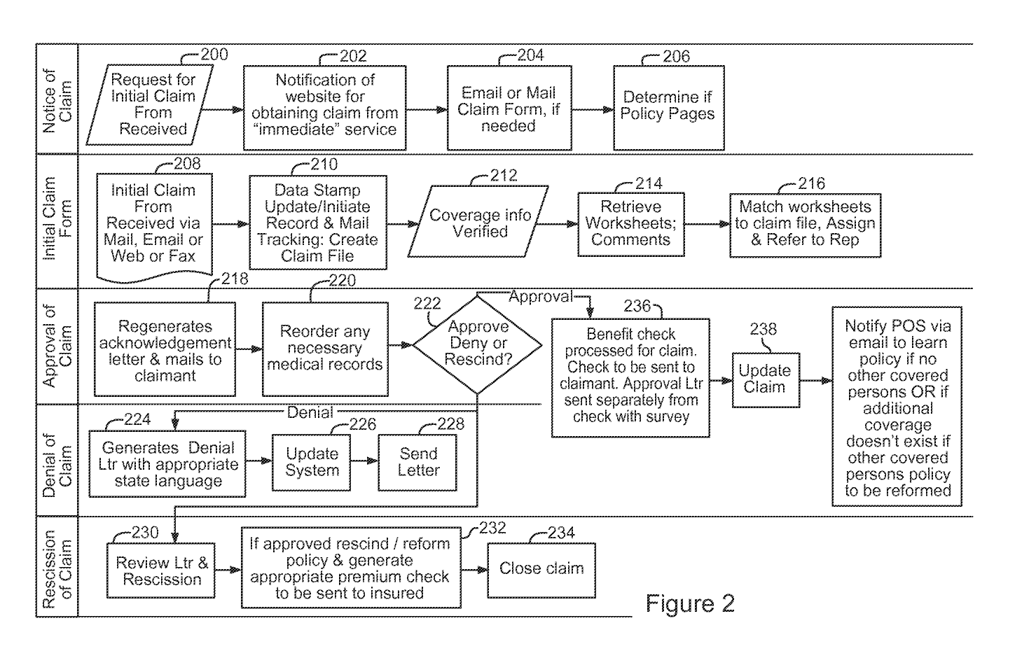

FIG. 2 is a flowchart of an exemplary workflow for processing insurance claims. A request for an initial claim form can be received by the insurance provider, e.g., at a computing system 100. For example, an insured that has contracted a critical illness can send a request for a claim form including information from the insured and their doctor. The insured can receive a notification to use a website to complete a claim form for fast service (202). Otherwise a claim form can be mailed or sent by email to the insured, if requested to be sent that way (204). The insured can send the information, for example, from a computer or mobile device 200, etc. of the insured. The computing system 100 of the insurance provider can determine if policy pages for the insured are in the system, and if not, the policy pages can be retrieved (206). The policy pages can describe the product that covers critical illnesses, e.g., as described herein. The critical illness policies are used for the sake of explanation of the systems, methods and products, but the systems, methods and products need not be limited to critical illness policies.

The initial claim form can be received by the insurance provider, e.g., via mail, email, fax, the Internet, etc. and entered into the computing system 100 (208). The claim form indicates the type of illness being claimed. The computing system 100 can date stamp the claim form, update/initiate record and mail tracking and create a claim file (210). Coverage worksheets are retrieved along with any comments to the claim 214). The worksheets can be matched to the claim file and assigned to insurance provider's representative (216). Subsequent or duplicate claims can be assigned to the same representative for the sake of consistency in handling the claim.

The computing system 100 can generate a claim acknowledgment letter and send it to the claimant (218). The computing system 100 can be used to order any medical records needed to be reviewed, e.g., automatically or by a medical expert, for approval of the claim 220). The claim can then be approved, denied or rescinded (222). If the claim is denied, the computing system 100 can generate a letter to the claimant stating the reasons for denial (224). The computing system 100 can be updated to indicate the denial under the policy and the claim is closed (226), and a close letter is sent to the claimant (228). If the claim is rescinded or reformed, the computing system 100 can generate a rescission/reform letter. If the policy is approved to be rescinded or reformed, e.g., by the insurance provider's legal department, a premium check with the rescission or reform language can be generated and sent to the insured (232). The claim can then be closed (234).

If the claim is approved, a benefit check is processed for payment of the claim (236). The benefit check is sent to the claimant in accordance with critical illness policies, for example, to cover various stages of illnesses that have reached a level of severity in which the person's personal and financial situation can be impacted. The claim is updated to a paid status (238).

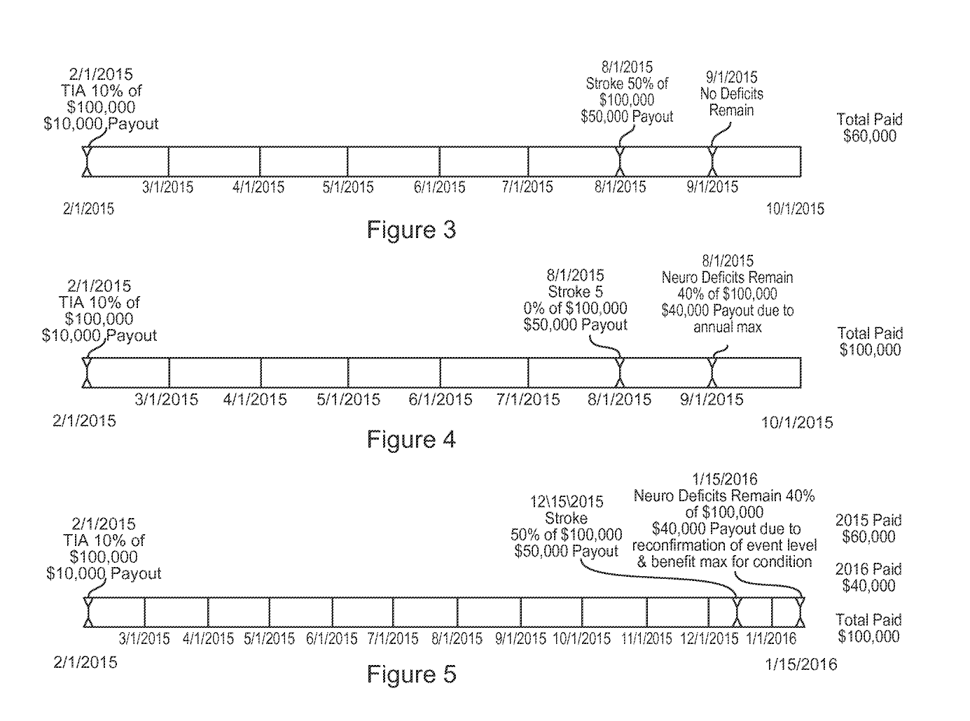

FIG. 3 is a block diagram of an exemplary payout for a cerebral vascular disease according to a first scenario. For purposes of explanation, the payouts are based on a maximum payout for the policy, e.g., $100,000 but other sized policies can be used.

In the cerebral vascular disease example, the policy can pay out benefits at staggered percentages of an annual maximum benefit amount, based on a financial impact that the critical illness may have on the client at different levels of the illness. If the patient has a transient ischemic attack (TIA, Mini-Stroke), a relatively minor condition compared to a stroke, the policy can pay a first percentage, e.g., 10% of the annual maximum benefit of $100,000, for a $10,000 payout. A stroke which has neurological effects that last less than a specific number of days, e.g. thirty days, can pay out a second percentage, e.g., 50%, for a $50,000 payout, even if it occurred within the same year as the TIA. Other time periods can be used. The staggered payments can provide for benefits to support a range of experiences that surrounds a critical illness. This addresses the current gap caused by the insurance industry's lack of benefits for not meeting specific severe illness definitions, despite the insured incurring medical expenses. Payment for early stages of the illness can also promote detection and encourage proper testing, e.g., by helping to pay for initial tests, follow-up tests and genetic tests.

In this way, the coverage can occur for a broad range of conditions, across all levels of severity. Benefits can be staggered at percentages, e.g., about 10%, about 50% or 100%, of an annual maximum benefit amount, based on the financial impact that a critical illness may have in a person's life. Other percentage amounts can be used. This provides coverage for the early stages of a critical illness, which may not have as significant of a financial impact, while also providing the covered person with the financial resources to intervene at an early stage with the goal of preventing a more severe condition in the future. For example, critical illnesses that indicate that a person is at a higher risk for having a more severe condition in the future, such the TIA/mini-stroke or an initial diagnosis of coronary artery disease, are payable under this coverage, providing the covered person with funds to choose treatment or implement life changes that may prevent a more serious condition from occurring.

FIG. 4 is a block diagram of an exemplary payout for a cerebral vascular disease according to a second scenario. A TIA pays a first percentage of the annual maximum benefit amount and a stroke which has neurological effects that last for a specific period of time e.g. more than 24 hours but less than thirty days pays a second percentage of the annual maximum benefit amount, e.g., 10% and 50% respectively. If that same stroke has neurological deficits which remain after a determined time period, e.g., thirty days, it can be paid at a third percentage, e.g., 40%, to provide the maximum policy payout at $100,000 for the year. This represents a full annual maximum payout for a spectrum of cerebral vascular disease. The payout for the stroke with neurological deficits remaining after a determined time period, e.g. thirty days is reduced by the previous payment for the same stroke with neurological deficits when thirty days had not yet passed. This provides early payment and funds for an insured for a stroke that may or may not have permanent effects, but for which significant medical expenses are incurred.

The systems, methods and products do not impose strict separation periods in order for a person to receive a benefit. Instead of requiring six months or another time period to pass between diagnoses, the systems and methods do not impose any time restrictions for payouts. A client can be eligible for payment no matter how close in time a diagnosis occurs to a previously paid diagnosis. Therefore, a person would not need to hope for a specific timeline of events to occur in order to access benefits under this insurance policy. Instead, each covered person is allowed a certain amount of benefits (annual maximum benefit amount) that refreshes each year, and the insured may submit any diagnosis received during that year to be eligible for payment no matter when it was received. Other time frames in alternative or in addition to the calendar year can be used, e.g., a year from the start of the policy, and other increments can be used, e.g., days or months.

FIG. 5 is a block diagram of an exemplary payout for a cerebral vascular disease according to a third scenario. The TIA and stroke which has effects lasting fewer than a specified time period e.g. thirty days, occur in the first calendar year and are paid in that year. If the stroke continues to have effects longer than thirty days and this occurs in the second calendar year, a remaining benefit of 40% of the annual maximum benefit amount is paid. This remaining benefits of 40% of the annual maximum benefit amount is limited because this scenario represents one progressing condition with a date of diagnosis that occurred in the first calendar year, and therefore it is considered under the annual maximum benefit amount for the first calendar year. If an insured were to experience a separate cerebral vascular event, they are eligible for renewed benefits. There can be no lifetime limitations on benefit payments for the systems and methods. Instead of limiting the number of overall payments under a policy to a specific number of identified critical illnesses, such as three total payouts per lifetime, the systems, methods and products have an annual maximum benefit amount, which refreshes every year throughout the lifetime of the policy, which allows a person to access benefits for newly diagnosed critical illnesses no matter when a critical illness occurs in their lifetime.

The levels of severity for cerebral vascular disease can be determined according to the following. Early identification, e.g., 10% payout, includes diagnosis of Transient Ischemic Attack (TIA) including Reversible Ischemic Neurologic Deficit (RIND) where there is a new ischemic event with no cerebral tissue damage and reversible impairment as confirmed by clinical diagnosis. The clinical diagnosis includes documentation of recommended treatment for stroke prevention. The impairment is focal and confined to an area of the brain perfused by a specific artery. An early stage of the illness, e.g., 50% payout, includes stroke with neurologic impairment (excluding TIA and RIND) which is confirmed by a neuroimaging study or by clinical diagnosis, which is the result of damage to brain tissue caused by either thrombosis, hemorrhage or embolism, and for which a physician has determined that the neurologic impairment resulted from the cerebral vascular event currently being diagnosed and was not previously present. Late stage, e.g., 100% payout, includes stroke with neurologic impairment (excluding TIA and RIND), which is confirmed by neuroimaging study, is a result of damage to brain tissue caused by either thrombosis, hemorrhage or embolism, and for which a physician has determined that the neurological impairment resulted from the cerebral vascular event currently being diagnosed, and was not previously present and has persisted for thirty days or longer.

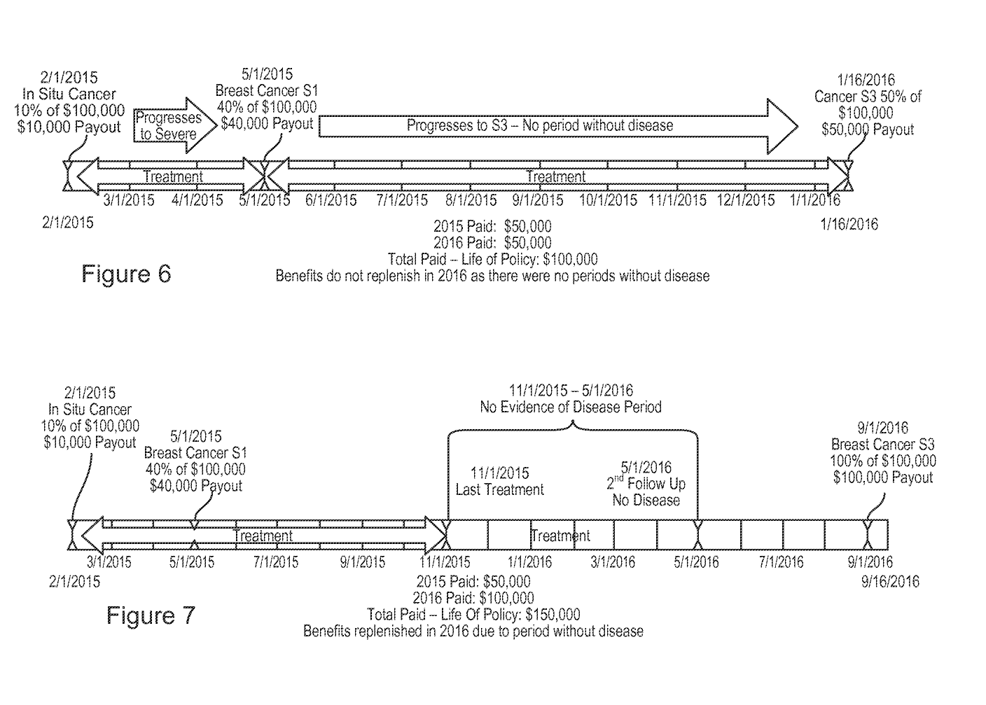

FIG. 6 is a block diagram of an exemplary payout for cancer according to a first scenario. In one example, in situ cancer, a relatively minor diagnosis compared to other cancers, can pay the insured at a first percentage of the annual maximum benefit amount of the policy for the year, e.g., 10% of $100,000 for a $10,000 payout. If the in situ cancer progresses to stage 1 breast cancer or other cancer, a second benefit is paid at a second percentage greater than the first percentage of the annual maximum benefit amount, e.g., 40% for a $40,000 payout. If the breast cancer progresses to stage 3 with no period without the disease, the rest of the annual maximum benefit amount is paid, e.g., the remaining 50% of the benefit is paid. The benefits did not replenish to the $100,000 in the next year because there were no periods without the disease from the S1 stage breast cancer to the S3 stage breast cancer. An insured is eligible for multiple payouts for one progressing condition, as each stage of cancer has costs associated with it. In today's market, an insured may not be eligible for a benefit until the last late stage of cancer, despite having incurred medical expenses for an extended period of time before the late stage began.

Some critical level type cancers can generate immediate full payout per the policy, e.g., pancreas, brain, esophagus, leukemia, lung, liver, biliary tract, head and neck, lymphoma or multiple myeloma, or they can be part of the staggered benefit payout systems, methods and products described herein.

FIG. 7 is a block diagram of an exemplary payout for cancer according to a second scenario. Both in situ cancer, e.g., early identification of the illness, and breast cancer S1, e.g., early stage of the illness are paid benefits, e.g., 10% and 40% of the annual maximum benefit amount respectively. Then a period of no evidence of disease occurs. The next year stage 3 breast cancer, e.g., late stage of the illness, is diagnosed and the full benefit of $100,000 is paid. Since the coverage replenishes each year, and the stage 3 breast cancer was a distinct condition due to a period of no evidence of disease passing between diagnoses, it is eligible for a 100% of the annual maximum benefit amount. Therefore, the insured received payments for multiple claims under the policy, the insured received various percentages of the maximum benefits for the different types of cancer, and the payments occurred over time as the disease progressed.

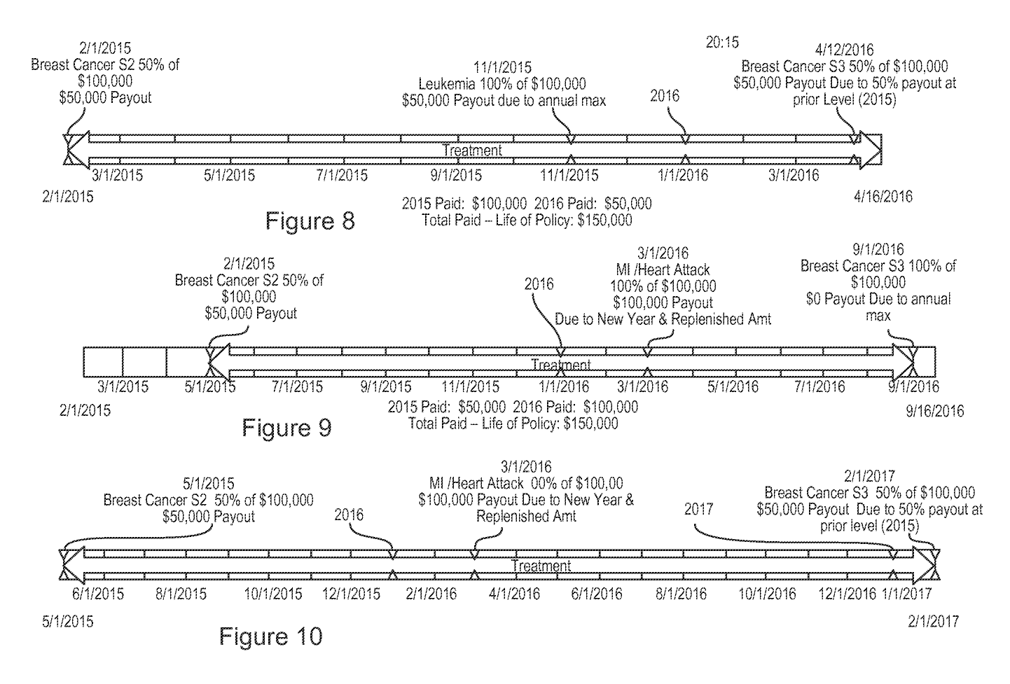

FIG. 8 is a block diagram of an exemplary payout for cancer according to a third scenario. The insured is paid a first percentage of the annual maximum benefit amount, e.g., 50%, for a diagnosis of stage 2 breast cancer. While receiving treatment for stage 2 breast cancer, and within the same policy year, the insured is diagnosed with another type of cancer, e.g., leukemia. Since a second separate cancer was diagnosed, the policy pays the insured again. Because $50,000 of the policy had already been paid for the stage 2 breast cancer in the same year as the leukemia diagnoses, the leukemia payout is maxed at the remainder of the policy payout for the year despite the condition being eligible for 100% of the annual maximum benefit amount, and thus is paid out at $50,000. The next year, while receiving treatment for the stage 2 breast cancer, the insured is diagnosed with stage 3 breast cancer. The $100,000 policy is recharged at the beginning of the new calendar year, but although stage 3 breast cancer is eligible for 100% of the annual maximum benefit amount, the insured is paid a percentage, e.g., 50%, of the maximum payout because the previous stage 2 breast cancer progressed and resulted in a higher benefit amount being payable, and the benefit due was reduced by the benefit amount previously paid for that cancer, regardless of the calendar year in which the progression occurred. If there had been a period of no evidence of the stage 2 breast cancer disease before the stage 3 breast cancer, the payout would be 100% of the annual maximum benefit amount.

FIG. 9 is a block diagram of an exemplary payout for cancer according to a fourth scenario. The insured is paid a percentage, e.g., 50%, of the annual maximum benefit amount for stage 2 breast cancer, e.g. $50,000. The next calendar year, the insured has a heart attack, which is eligible for 100%, payout of the annual maximum benefit amount, e.g., $100,000. During the same year as the heart attack, the insured is diagnosed with stage 3 breast cancer. Since the policy already paid 100% of the annual maximum for the calendar year, no other payout occurs that year.

The systems, methods and products do not include a reduction in payment upon recurrence of the same critical illness, nor are there any limits to how many recurrence payments a person is eligible for. The critical illness policies offer substantial coverage for when an insured has a recurrence of the same critical illness. If there is a benefit for a recurrence of a critical illness, the benefit amount payable is not reduced for the recurrence and the number of payouts are not limited. There is also no need for a specific time period (“separation period”) to elapse before the diagnosis of a reoccurrence (e.g. six months to a year) in order to be eligible for a benefit. For example, a recurring condition can be payable for more than a few specific conditions, at a full rate of the initial benefit amount, without a lifetime maximum of recurrence payouts, and without a specific time period elapsing between diagnoses. The systems, methods and products can provide insurance coverage that addresses the spectrum of events surrounding a critical illness and provide the insured with a lifetime of protection.

FIG. 10 is a block diagram of an exemplary payout for cancer according to a fifth scenario. The insured is paid a percentage, e.g., 50%, of the annual maximum benefit amount for stage 2 breast cancer, e.g. $50,000. The next calendar year, the insured has a heart attack and receives a percentage, e.g., 100% of the annual maximum benefit amount, e.g., $100,000, due to the policy being replenished for the new calendar year. The next year, the insured is paid a percentage, e.g., 50%, of the replenished annual maximum benefit amount for stage 3 breast cancer, e.g. $50,000. The stage 3 breast cancer is a continuation of the stage 2 breast cancer, with no period of no evidence of stage 2 cancer disease between diagnoses. Therefore, the payment for the stage 3 breast cancer is reduced by benefit amounts previously paid for that cancer. If a period of no evidence of disease elapsed between the stage 2 and the stage 3 breast cancer, the stage 3 breast cancer payment is not tied to the stage 2 cancer payment, and $100,000, the policy's annual maximum benefit amount paid.

The levels of severity for cancer can be determined according to the following. Early identification, e.g., 10% payout, includes pathological diagnosis of any of the following conditions: Invasive Squamous-cell and Basal-cell skin cancers; In-situ cancers, excluding non-invasive Basal-cell and non-invasive Squamous-cell skin cancers; Benign tumors of the central nervous system (brain, spinal cord, cranial nerve); and Myelodysplastic syndrome. High risk indicators or an early stage of the illness, e.g., 50% payout, includes pathological diagnosis of any of the following conditions: Stage 1 Melanoma, Stage 1 or 2 of any localized cancer without lymph node involvement. Late stage, e.g., 100% payout, includes pathological diagnosis of any of the following conditions: Multiple Myeloma; Leukemia; Stage 1 or higher pancreatic, esophageal, lung, liver, biliary tract, or head and neck cancer, or lymphoma, Stage 2 with lymph node involvement, or any Stage 3 or 4 of any cancer. If cancer is not confirmed by pathological diagnosis, but instead confirmed by clinical diagnosis because pathological diagnosis would be medically inappropriate or life-threatening, the benefit will be 50% of the benefit otherwise available for that condition if it were diagnosed by pathological diagnosis.

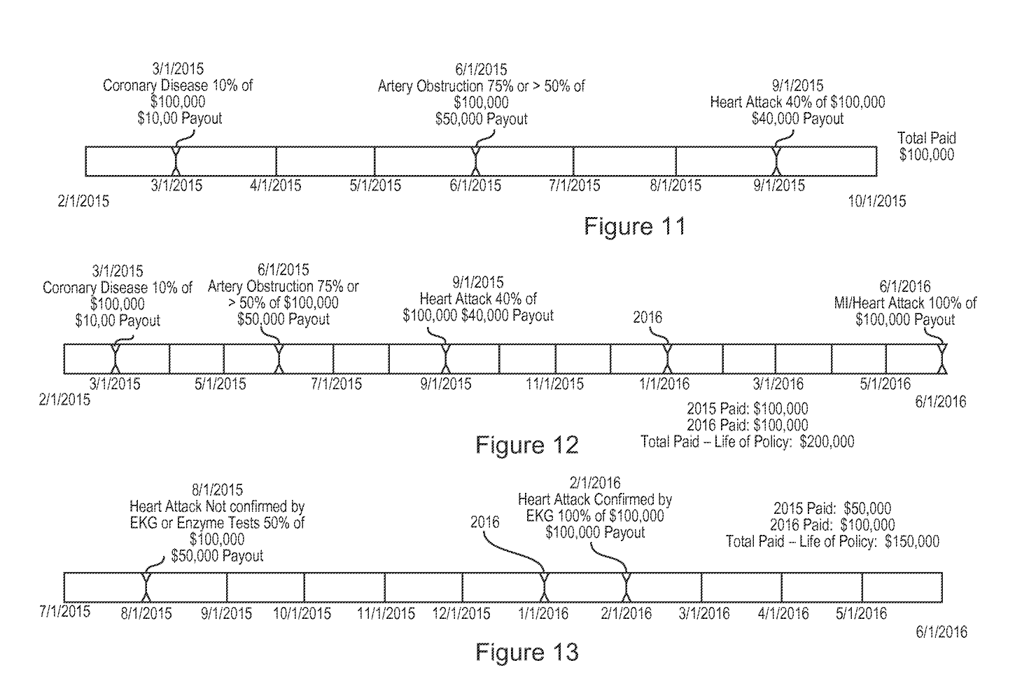

FIG. 11 is a block diagram of an exemplary payout for coronary artery diseases according to a first scenario. The insured receives an initial diagnosis of coronary artery disease and receives treatment, e.g., medication, cardiac rehabilitation, nutritional/diet therapy and/or cardiac risk factor modification. The policy pays a determined percentage, e.g., 10%, of the annual maximum benefit amount, e.g., pays $10,000 for a diagnosis of coronary artery disease. A coronary artery obstruction later occurs, e.g., where 75% or more of the artery is obstructed. This is a separate condition than the diagnosis of coronary artery disease and a payout of a second determined percentage, e.g., 50% of the annual maximum benefit amount, is paid to the insured, e.g., $50,000 for a $100,000 policy. Later that year the insured has a heart attack and although the heart attack is payable at 100% of the annual maximum benefit amount, since the insured has already received 60% of the annual maximum benefit amount that year, the heart attack benefit is capped at the remaining 40% of the annual maximum benefit amount for that year. In this way, the insured was able to receive payments under the policy for stages of the disease that occurred before the late stage policy event occurred, e.g., before the heart attack occurred.

FIG. 12 is a block diagram of an exemplary payout for coronary artery diseases according to a second scenario. The insured receives an initial diagnosis of coronary artery disease and the policy pays a determined percentage, e.g., 10%, of the annual maximum benefit amount, e.g., pays $10,000. In the same year, the insured has a coronary artery obstruction, e.g., where 75% or more of the artery is obstructed. A payout of a second determined percentage, e.g., 50% of the annual maximum benefit amount, is paid to the insured, e.g., $50,000 for a $100,000 policy. Later that year the insured has a heart attack and although a heart attack is eligible for 100% of the annual maximum benefit amount, payment is capped at the annual maximum benefit amount and since the insured has already received 60% of the annual maximum benefit amount for that year, the remaining 40% is paid, for a total of $100,000 in payouts under the policy for the year. The policy resets the next calendar year and the insured suffers another heart attack. The policy pays 100% of the annual maximum benefit amount for the second heart attack, e.g., $100,000, the year after the policy paid $100,000, because it is a new calendar year.

FIG. 13 is a block diagram of an exemplary payout for coronary artery diseases according to a third scenario. The insured is diagnosed with a heart attack but it is not confirmed by an electrocardiogram (EKG) or enzyme test, rather it is confirmed by clinical diagnosis. The insured is paid a determined percentage, e.g., 50%, of the annual maximum benefit amount for a heart attack confirmed clinically. During the next calendar year the insured suffers a heart attack confirmed by the EKG and is paid 100% of the annual maximum benefit amount, e.g., $100,000.

The levels of severity for coronary scenarios can be determined according to the following. Early identification, e.g., 10% payout, includes initial diagnosis of coronary artery disease (other than coronary artery obstruction with at least 75% cross-sectional occlusion) as confirmed by clinical diagnosis with invasive or non-invasive assessment, and documentation of recommended treatment including any of the following: medication, cardiac rehabilitation, nutritional/diet therapy, and cardiac risk factor modification. Discovery of high risk indicators or an early stage of the illness, e.g., 50% payout, include Heart attack with evidence of new death of heart muscle as confirmed by clinical diagnosis and Coronary Artery Obstruction (including acute coronary syndrome with PCI) as confirmed by coronary angiography procedure where the angiography is interpreted by a qualified cardiologist, cardiac surgeon or interventional radiologist and angiography showing at least 75% cross-sectional occlusion of one or more coronary arteries. Late stage indicators, e.g., 100% payout, includes Heart Attack with evidence of new death of heart muscle as confirmed by EKG test and elevation of cardiac enzymes or biochemical markers showing a pattern and to a level consistent with a diagnosis of heart attack.

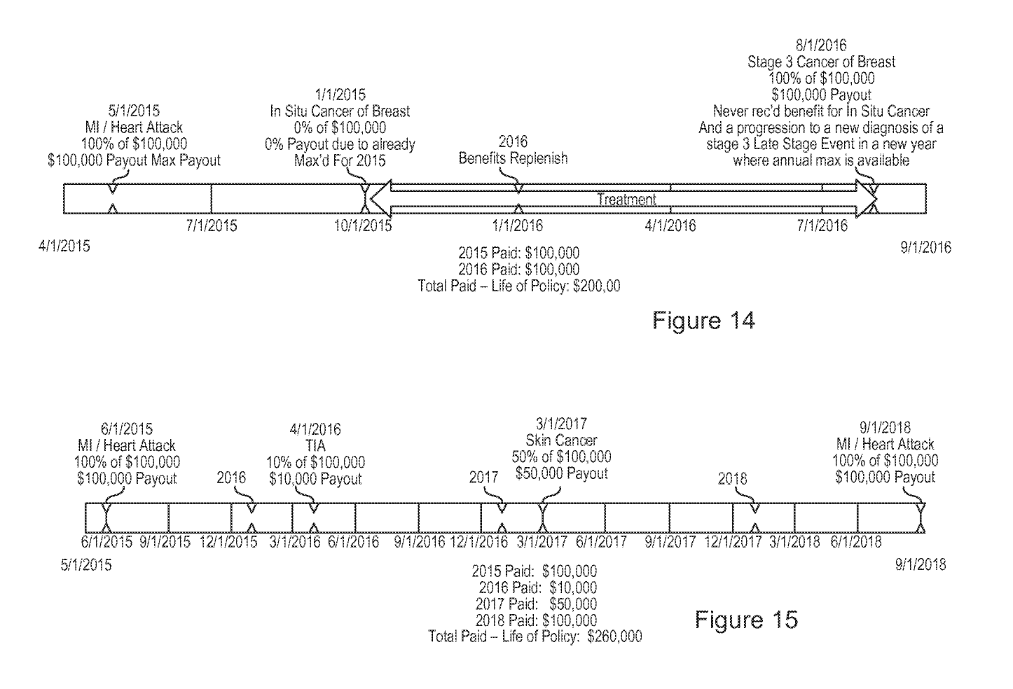

FIG. 14 is a block diagram of an exemplary payout for multiple conditions according to a first scenario. The insured suffers a heart attack and is paid 100% of the annual maximum benefit amount, e.g. $100,000. That same year the insured is diagnosed with in situ breast cancer. Since the full annual maximum benefit amount had been paid for the year, the insured receives no additional payment for the in situ breast cancer. In a subsequent year, the insured is diagnosed with stage 3 breast cancer. The policy replenished with the new year so the insured receives 100% of the annual maximum benefit amount, e.g., $100,000. The insured receive 100% even if there was no period of no disease between the in situ breast cancer diagnosis and the stage 3 breast cancer because the insured never received a benefit for the in situ cancer due to the annual maximum benefit amount being maxed out in the previous year.

FIG. 15 is a block diagram of an exemplary payout for multiple conditions according to a second scenario. The insured suffers a heart attack and is paid 100% of the annual maximum benefit amount, e.g. $100,000. The next year the insured receives a diagnosis of TIA and receives a determined percentage of the annual maximum benefit amount, e.g., 10% for a relative minor condition, or $10,000 of the $100,000 policy. The insured receives money even though the maximum payout had previously been paid because the policy regenerated with the new year. The next year the insured is diagnosed with skin cancer and is paid a determined percentage of the of the annual maximum benefit amount, e.g., 50% or $50,000 of the $100,000 policy. The next year the insured suffers a heart attack and is paid 100% of the annual maximum benefit amount, e.g. $100,000.

While staggered benefits based on severity of illness for cerebral vascular disease, coronary artery disease and cancer represent the critical illness needs that most insureds will face in their lifetimes, additional conditions are also covered to provide comprehensive critical illness coverage. These conditions are paid as a percentage of the annual maximum benefit amount. Each condition is payable only once per lifetime and include the following : Blindness which means permanent loss of visual acuity based on either best corrected visual acuity of 20/400 or worse, or visual field of 20 degrees or worse in the better eye, without expectation for improvement; Complications of Diabetes, when a covered person diagnosed by a physician as having diabetes has an amputation of a lower limb, which includes all areas at or above the forefoot, as a result of the diabetic condition; Loss of Hearing which means clinically-proven irreversible loss of hearing in both ears, with anticipated best corrected auditory threshold of more than 90 decibels, through surgery, hearing aid, device or implant; Major Organ Failure of one of the following organs: liver, lung, pancreas or heart; Occupational Human Immunodeficiency Virus (HIV) where the contracting of HIV is caused by a needle stick or sharp injury or a mucous membrane exposure to blood or bloodstained bodily fluid which meets all of the following requirements: (1) The needle stick or sharp injury occurred after the rider effective date, (2) The incident occurred while the covered person was following his or her normal occupational duties and was reported to the employer within 5 days, and (3) Serum HIV blood test is obtained within one week of the reported injury and is negative with a subsequent positive test obtained between 90 and 180 days after accidental injury; Paralysis where there is clinical diagnosis of a complete and irreversible condition marked by loss of muscle function in two or more limbs (paraplegia, quadriplegia, hemiplegia) as the direct result of an illness or disease, which is not expected by a physician to reverse or resolve; Chronic Renal Failure, which is the irreversible failure of the function of both kidneys such that regular dialysis is required to sustain life; Lupus, Sarcoid or central nervous infection of the brain which leads to brain damage resulting in neurologic impairment which meets all of the following requirements: (1) Is objectively measured, (2) Is confirmed by neuroimaging studies, and (3) A medical professional has determined that neurological impairment resulted from the condition currently being diagnosed and was not previously present and has persisted for 30 days or longer; Life threatening complications due to diabetes characterized by extreme hyperglycemia and dehydration, and a physician's determination that immediate hospitalization is necessary; Stem Cell/Bone Marrow Transplant when there is infusion or injection of healthy stem cells into the body to replace damaged or diseased stem cells

To provide a spectrum of coverage that addresses events that a person is most likely to encounter with regard to a critical illness, the coverage of the systems, methods and products can also include a benefit for when a person provides caregiving services to a family member, who is not covered by the policy, who is suffering from a critical illness that would be eligible for payment under the policy if the insured was diagnosed with it. Though individuals may not themselves ever get a critical illness, the policy can provide care for a family member who is stricken by a covered critical illness. This recognizes that a critical illness has effects on many parties, not just the person who has the critical illness.

Eligible family members include the insured or their spouse, the insured's natural or legally adopted children including existing children of the insured's spouse, the insured or the insured spouse's natural or step-parents, and the insured or the insured spouse's natural or step-siblings. Care includes assistance to another individual with home health care, homemaking or transportation. Home health care includes personal care including assistance with bathing, dressing and personal hygiene, feeding, dressing changes, monitoring of vital signs, body positioning and basic exercise, medication administration, or supervision for safety. Homemaking includes assistance with light housekeeping, shopping and meal preparation, laundry, medication management, or bill paying. Transportation includes assisting individual in order to access needed services outside of the home for medical professional services or rehabilitative care. Care can also be provided in any combination of the categories.

Benefits are payable when a covered person is providing care to an eligible family member. The care is due to an eligible family member's diagnosis of the covered illnesses, e.g., cancer, coronary artery disease or cerebral vascular disease. To be payable, the need of care can be certified by a physician as being required for two weeks (other time frames can be used), care is provided by the same covered person three days per week for at least two weeks, and the eligible family member's diagnosis for which care is needed occurs after the insurance is effective. The caregiver benefit can be payable once per eligible family member during the lifetime of the policy. In some implementations, more than one covered person is not eligible to receive a benefit for the same eligible family member. The benefit is subject to the maximum benefit amounts as specified in the policy.

The systems, methods and products offer coverage for early identification and/or the early stages of a critical illness and comprehensive coverage for the spectrum of events surrounding a critical illness that individuals are most likely to encounter. For example, instead of only paying out a claim only when a critical illness meets a specific and restrictive definition, the systems, methods and products allow for other benefits, e.g., if that illness has an impact on a person's life that they are unable to lead an independent lifestyle.

Therefore, the systems, methods and products can provide benefits for early identification of critical illnesses. Benefits are available for screening tests, follow-up tests, or genetic tests that identify the presence or possibility of a critical illness. Covered persons can be given access to a medical advice service that provides second opinions and treatment recommendations when a diagnosis is rendered, e.g., from medical experts who are thought leaders in their industry.

There are various way by which systems, method, products and/or other technologies described herein can be effected, e.g., hardware, software, and/or firmware. There may be little distinction between hardware and software implementations of aspects of systems.

When used in a WAN networking environment, computing system 100 can include a modem or other means for establishing communications over the WAN, such as radio 198, to environments such as the Internet. Other means of establishing a communications link between computing system 100 and other computers may be used. In one example, the mobile device 200 includes input 210 for entering information from a user into the mobile device 200. Input 210 includes any device which can assist a user to enter information, such as a keyboard, a mouse, a touchpad, a touchscreen, and the like. For example, the mobile device 200 may display a question to an individual pertaining to the claim.

The mobile deice 200 can include such devices as a personal digital assistant (PDA), a portable computer, a mobile telephone, a smartphone, a netbook, a mobile vehicular computer, and a tablet computer. The mobile device 200 also includes a communications device 208. Communications device 208 is capable of wirelessly transmitting signals to another computer, such as remote server 240, using a radio transmitter and a radio receiver connected with an antenna.

The individual may use the input means 210 to input an answer to the question. Data associated with the individual's answer may be transmitted from the mobile device 200, over the network 226, and to the remote server 240 where further steps associated with the systems and methods of the present disclosure may be performed (e.g., coverage determination, etc.).

Computing system 100 may operate in a networked environment using logical connections to one or more remote computers, such as a remote server 240. The remote server 240 may be a personal computer, a server, a router, a network PC, a peer device or other common network node, and may include many if not all of the elements described above relative to computing system 100. Networking environments in offices include enterprise-wide computer networks, intranets and the Internet. For example, computing system 100 may include the source machine from which data is being migrated, and the remote computer may include the destination machine. Source and destination machines need not be connected by a network or any other means, but instead, data may be migrated via any media capable of being written by the source platform and read by the destination platform or platforms.

Communications device 208 communicates with another computing system 100, such as remote server 240, via a network 226 using a network interface 209. Network interface 209 is connected with processor 201 and communications device 208, and may be disposed within remote device 200. Network 226 may include any type of network that is capable of sending and receiving communication signals, including signals for multimedia content, images, data and streaming video. Network 226 may include a data network, such as the Internet, an intranet, a local area network (LAN), a wide area network (WAN), a cable network, and other like systems that are capable of transmitting information, such as digital data, and the like. Network 226 may also include a telecommunications network, such as a local telephone network, long distance telephone network, cellular telephone network, satellite communications network, cable television network and other like communications systems that interact with computing system 100s to enable transmission of information between mobile device 200 and another computer such as remote server 240. Network 226 may be included of more than one network and may include a plurality of different types of networks. Thus, network 226 may include a plurality of data networks, a plurality of telecommunications networks, cable systems, satellite systems and/or a combination of data and telecommunications networks and other like communication systems.

Network 226 is connected with both mobile device 200 and remote server 240 and allows for information to be transmitted and shared between mobile device 200 and remote server 240. Remote server 240 includes any type of computer which can receive, store, process, and transmit information to another computer and includes devices such as a server based computing system 100 capable of interacting with one or more other computing system 100s.

Input devices 190 can include an electronic digitizer, a flatbed scanner, a barcode reader, a microphone, a camera, a video camera, a keyboard and a pointing device, commonly referred to as a mouse, a trackball or a touch pad, a pinpad, any USB device, any Bluetooth enabled device, an RFID or NFC device, a debit card reader, etc. Other input devices may include a joystick, game pad, satellite dish, scanner, and the like. In one or more examples, input devices 190 may direct display or instantiation of applications running on processor 110. Radio 198 may wirelessly transmit and receive data using WiMAX™, 802.11a/b/g/n, Bluetooth™, 2G, 2.5G, 3G, 4G, or other wireless standards.

The detailed description has set forth various embodiments of the systems, products, methods and/or processes via the use of block diagrams, schematics, flowcharts, and/or examples. Insofar as such block diagrams, schematics, flowcharts, and/or examples contain one or more functions and/or operations, each function and/or operation within such block diagrams, schematics, flowcharts, or examples can be implemented, individually and/or collectively, by a wide range of hardware, software, firmware, or virtually any combination thereof. Several portions of the subject matter described herein may be implemented via Application Specific Integrated Circuits (ASICs), Field Programmable Gate Arrays (FPGAs), digital signal processors (DSPs), or other integrated formats. Aspects, in whole or in part, can be equivalently implemented in integrated circuits, as one or more computer programs running on one or more computers, e.g., as one or more programs running on one or more computing system 100s, as one or more programs running on one or more processors, e.g., as one or more programs running on one or more microprocessors, as firmware, or as any combination thereof.

The mechanisms of the subject matter described herein are capable of being distributed as a program product in a variety of forms. Signal bearing medium used to actually carry out the distribution include, but are not limited to, the following: a computer readable memory medium such as a magnetic medium like a floppy disk, a hard disk drive, and magnetic tape; an optical medium like a Compact Disc (CD), a Digital Video Disk (DVD), and a Blu-ray Disc; computer memory like random access memory (RAM), flash memory, and read only memory (ROM); and a transmission type medium such as a digital and/or an analog communication medium like a fiber optic cable, a waveguide, a wired communications link, and a wireless communication link.

The subject matter sometimes illustrates different components contained within, or connected with, different other components. It is to be understood that such depicted architectures are merely exemplary, and that many other architectures can be implemented which achieve the same functionality. Any two components herein combined to achieve a particular functionality can be seen as associated with each other such that the desired functionality is achieved, irrespective of architectures or intermediate components. Likewise, any two components so associated can also be viewed as being operably connected, or operably coupled, to each other to achieve the desired functionality, and any two components capable of being so associated can also be viewed as being operably couplable, to each other to achieve the desired functionality. Specific examples of operably couplable include, but are not limited to, physically mateable and/or physically interacting components, and/or wirelessly interactable and/or wirelessly interacting components, and/or logically interacting and/or logically interactable components.

The drawing and description in this disclosure are proffered to facilitate comprehension of the present disclosure, and should not be construed to limit the scope thereof. While particular aspects of the present subject matter described herein have been shown and described, changes and modifications may be made without departing from the subject matter described herein and its broader aspects and, therefore, the appended claims are to encompass within their scope all such changes and modifications as are within the true spirit and scope of the subject matter described herein. The present disclosure is defined by the appended claims. Accordingly, the present disclosure is not to be restricted except in light of the appended claims and their equivalents.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. The following claims are hereby incorporated into the Detailed Description, with each claim standing on its own as a separately claimed subject matter.

1. A method, comprising:
receiving a claim based on an insurance policy for an illness;
determining, by a processor, a level of severity of the illness based on the claim;
determining, by the processor, a benefit payout where the benefit payout comprises a staggered percentage of a maximum payout under the insurance policy based on the level of severity of illness; and
paying the benefit payout.

2. The method of claim 1, where the level of severity comprises an early identification of the illness, an early stage of the illness and a late stage of the illness.

3. The method of claim 2, where the staggered percentage comprises about ten percent for the early identification of the illness, about fifty percent for the early stage of the illness, and one hundred percent for the late stage illness.

4. The method of claim 1, where the illness comprises at least one of cancer, coronary artery disease and cerebral vascular disease.

5. The method of claim 1, where a transient ischemic attack is paid a first percentage of the maximum payout, stroke is paid a second percentage of the maximum payout greater than the first percentage, and the maximum payout is paid for neuro deficits.

6. The method of claim 1, where an in situ cancer is paid a first percentage of the maximum payout, stage one cancer is paid a second percentage of the maximum payout greater than the first percentage, and the maximum payout is paid for stage three cancer.

7. The method of claim 1, where a coronary disease is paid a first percentage of the maximum payout, artery obstruction is paid a second percentage of the maximum payout greater than the first percentage, and the maximum payout is paid for a heart attack.

8. The method of claim 1, where the maximum payout replenishes after a year.

9. The method of claim 8, where the maximum payout replenishes at the beginning of the year.

10. The method of claim 1, where there is no required separation period between benefit payouts.

11. A method, comprising:
receiving, by a processor, a claim that indicates a type of illness;
determining a severity of the illness; and
determining a benefit payout based on the severity of illness, where the benefit payout comprises a first percentage of a maximum payout or a second percentage of the maximum payout greater than the first percentage based on the determined severity of the illness.

12. The method of claim 11, where the severity of illness comprises an early identification of the illness, an early stage of the illness and a late stage of the illness.

13. The method of claim 12, where the first percentage comprises about ten percent for the early identification of the illness and the second percentage comprises about fifty percent for the early stage of the illness.

14. The method of claim 13, further comprising paying one hundred percent for the late stage illness.

15. The method of claim 11, where a transient ischemic attack is paid the first percentage of the maximum payout, stroke is paid the second percentage of the maximum payout and neuro deficits are paid the maximum payout less any amount already paid unless the maximum payout is replenished.

16. The method of claim 11, where in situ cancer is paid the first percentage of the maximum payout, stage one cancer is paid the second percentage of the maximum payout and stage three cancer is paid the maximum payout less any amount already paid unless the maximum payout is replenished.

17. The method of claim 11, where coronary disease is paid the first percentage of the maximum payout, artery obstruction is paid the second percentage of the maximum payout and the maximum payout is paid for a heart attack less any amount already paid unless the maximum payout is replenished.

18. The method of claim 11, where the maximum payout replenishes after a year.

19. A system, comprising:
a processor connected with a computer readable memory medium, the computer readable medium to provide storage of computer readable instructions, the processor to execute the computer readable instruction to:
determine a severity of an illness from a received insurance claim, where the illness comprises at least one of cancer, coronary artery disease and cerebral vascular disease; and
determine a benefit payout based on the severity of illness, where the benefit payout comprises a first percentage of a maximum payout or a second percentage of the maximum payout greater than the first percentage based on the determined severity of the illness;
where the first percentage comprises about ten percent of the maximum payout for an early identification of the illness and the second percentage comprises about fifty percent of the maximum payout for the early stage of the illness, and the maximum payout is paid for a late stage illness less any amount already paid unless the maximum payout is replenished.

20. The system of claim 19, where there is no required separation period between payouts.
